(19) United States
(12) Patent Application Publication
(10) Pub. No.: US 2018/0109521 A1
(43) Pub. Date: Apr. 19, 2018

(54) METHOD OF MUTUAL AUTHENTICATION BETWEEN AGENT AND DATA MANAGER IN U-HEALTH ENVIRONMENT

(71) Applicant: Industry-Academic Cooperation Foundation Halla University, Wonju-si (KR)

(72) Inventor: Soon Seok KIM, Wonju-si (KR)

(73) Assignee: Industry-Academic Cooperation Foundation Halla University, Wonju-si (KR)

(21) Appl. No.: 15/384,773

(22) Filed: Dec. 20, 2016

(30) Foreign Application Priority Data
Oct. 14, 2016 (KR) 10-2016-0133765

(51) Int. Cl. H04L 29/06

(52) U.S. Cl. CPC H04L 63/0869; H04L 63/0861

(57) ABSTRACT

Disclosed is a method of mutual authentication between an agent and a data manager in a u-health environment, in which the agent performs identification recognition using an identification (ID) of the agent, i.e., a System-id, a secret key, encryption, and a one-time use random number generator, instead of using biometric scan data of an existing IEEE 11073 agent, and hence bidirectional authentication, rather than unidirectional authentication, is allowed.

### CROSS-REFERENCE TO RELATED APPLICATION

This application claims priority to and the benefit of Korean Patent Application No. 10-2016-0133765, filed on Oct. 14, 2016, the disclosure of which is incorporated herein by reference in its entirety.

### BACKGROUND

### 1. Field of the Invention

The present invention relates to a method of mutual authentication between an agent and a data manager in a u-health environment, in which the healthcare management center acts as an authentication server and authentication of an identification of the subject is performed between the agent and the data manager using encryption and a one-time use random number generator when personal biometric information of a subject is measured through the agent and the data manager collects the biometric information and transmits the collected information to a healthcare management center.

### 2. Discussion of Related Art

In 2013, The International Organization for Standardization (ISO) and The Institute of Electrical and Electronics Engineers (IEEE) of the U.S. revised the international standard ISO/IEEE 11073 for elderly living alone or patients at home in a “tele-healthcare” or “tele-medicine” environment (also known as “e-health” or “u-health”).

This standard is aimed at those geographically far away from hospitals, including elderly living alone, handicapped, people living on islands and highlands, and chronic disease patients.

Referring to FIG. 1, a biosensor, known as a personal health device (PHD), is used in a home to measure various kinds of biometric information, such as an electrocardiogram (ECG), a pulse, a body temperature, a blood pressure, and the like, and communicates with a data manager (DM), which collects the information, through wired or wireless two-way communication.

The DM transmits personal biometric information, which is regularly measured and collected, to a healthcare management center (HMC) or, in an emergency, to an emergency medical care center using an ambulance.

In this case, a nurse or a doctor is usually resident at a separate place in the HMC and is in charge of healthcare of the above mentioned chronic disease patients at home.

ISO and IEEE established the ISO/IEEE 11073-20601 standard for mutual communication between a PHD and a DM, and have announced a series of ISO/IEEE 11074-104zz standards for devices used for communication.

Biometric information related to patients' or individuals' health is personal information. Therefore, privacy of such information should be protected, and the information should neither be illegally accumulated, nor distributed by illegal third parties. These points are specified by law in each country.

However, no international standard or country has yet proposed a specific and clear method for mutual communication between a PHD and a DM.

In 2010, Appari and Johnson stressed the importance of protection of information in a healthcare environment (A. Appari, and M. E. Johnson,

“Information security and privacy in healthcare: current state of research”, Int. J. Internet and Enterprise Management, v. 6, n. 4, pp. 279-314, 2010) and in 2012, Kumer and Lee mentioned the necessity of policies regarding security in a healthcare environment (P. Kumar and H. J. Lee, “Security Issues in Healthcare Applications Using Wireless Medical Sensor Networks: A Survey”, Sensors, v. 12, pp. 55-91, 2012).

Also, in 2012, Kliem and others proposed architecture for secure communication in a PHD mobile environment (A Kliem, M Hovestadt, and O Kao, “Security and Communication Architecture for Networked Medical Devices in Mobility-Aware eHealth Environments”, IEEE First International Conference on Mobile Services (MS), 2012).

However, there has been no proposal for a mutual authentication scheme between a PHD and a DM.

FIG. 2 is a flowchart illustrating a method of authenticating a user of an IEEE 11073 agent using a biometric information scanner according to a related art that is disclosed in Korean Patent Application Publication No. 10-2014-0079152 (published on Jun. 26, 2014).

Referring to FIG. 2, the method includes: a step in which a scanner agent, which has a function of generating biometric scan data through a scan of a specific human body part for identification recognition and acts as the IEEE 11073 agent, transmits an association request message including the biometric scan data to an IEEE 11073 manager; a step in which the IEEE 11073 manager transmits the biometric scan data to a user authentication server in response to the association request message; and a step in which the IEEE 11073 manager receives authentication result information based on the biometric scan data from the user authentication server.

The method of authenticating an IEEE 11073 agent user using a biometric information scanner is compatible with the existing IEEE 11073 international standard and can authenticate the user of the IEEE 11073 agent. When the biometric information measurement data measured by the IEEE 11073 agent is provided to a u-health server that provides a u-health service, authentication information of an authenticated user, for example, identification information, is also provided, and thus it may be helpful for the u-health server to collect biometric information measurement data of each user. In addition, user information is stored in the IEEE 11073 manager only when the association is being established between the IEEE 11073 manager and the IEEE 11073 agent, and since the user information is immediately deleted when the association is released, leakage of information of another user can be prevented or the biometric information measurement data can be prevented from being erroneously processed as data of another user.

However, since the method of authenticating an IEEE 11073 agent user using a biometric information scanner according to the related art is implemented by varying a System-id, which is an ID of an agent used in the IEEE 11073-20601 standard, for each user, a scanner agent needs to add separate biometric scan data to the existing IEEE 11073 agent (AARQ[+Biometric scan data]). That is, a function of generating biometric scan data through a scan of a specific human body part for identification recognition must be provided.

### RELATED ART DOCUMENTS

### Patent Document

Patent document 1: Korean Patent Application Publication No. 10-2014-0079152 (Published on Jun. 26, 2014)

### Non-Patent Document

Non-patent document 1: (Cited reference 1) A. Appari, and M. E. Johnson, “Information security and privacy in healthcare: current state of research”, Int. J. Internet and Enterprise Management, v. 6, n. 4, pp. 279-314, 2010.]

Non-patent document 2: (Cited reference 2) P. Kumar and H. J. Lee, “Security Issues in Healthcare Applications Using Wireless Medical Sensor Networks: A Survey”, Sensors, v. 12, pp. 55-91, 2012.

Non-patent document 3: (Cited reference 3) A Kliem, M Hovestadt, and O Kao, “Security and Communication Architecture for Networked Medical Devices in Mobility-Aware eHealth Environments”, IEEE First International Conference on Mobile Services (MS), 2012.

### SUMMARY OF THE INVENTION

In order to solve the above-described problems of the related art, the present invention provides a method of mutual authentication between an agent and a data manager in a u-health environment capable of bidirectional authentication rather than unidirectional authentication because the agent performs identification recognition using an identification (ID) of the agent, i.e., a System-id, a secret key, encryption, and a one-time use random number generator instead of using biometric scan data of an existing IEEE 11073 agent.

In one general aspect, there is provided a method of mutual authentication between an agent and a data manager in a u-health environment in which the data manager collects biometric information of a subject obtained from a plurality of agents and transmits the biometric information to an authentication server, the method including: mutually recognizing devices of the data manager and each of the agents and performing mutual authentication using a random number generated by a random number generator; transmitting the collected biometric information between each of the agents and the data manager after the recognition of the device and the mutual authentication; and terminating a connection between each of the agents and the data manager when the transmission of the biometric data is finished.

The performing of the mutual authentication may include a first process in which the data manager requests personal authentication of the subject from the agent, a second process in which the agent responds to the request for authentication from the data manager, a third process in which the data manager authenticates an identification of the agent and requests that the authentication server verifies the identification of the agent, a fourth process in which the authentication server verifies the identification of the agent and transmits the verification result to the data manager, a fifth process in which the data manager requests that the agent authenticates an identification of the data manager, and a sixth process in which the agent authenticates the identification of the data manager.

The agent, the data manager, and the authentication server in a u-health environment specified by international standard IEEE 11073 may be configured to measure and collect personal biometric information at a home and transmit the personal biometric information to a healthcare management center.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a system configuration of a general u-health environment;

FIG. 2 is a flowchart illustrating a method of authenticating a user of an IEEE 11073 agent using a biometric information scanner according to a related art;

FIG. 3 is a diagram illustrating a system configuration of a u-health environment for implementing the present invention;

FIG. 4 is a flowchart illustrating ISO/IEEE 11073-20601 communication procedures for implementing the present invention;

FIG. 5 is a flowchart illustrating an overall process of mutual authentication between an agent and a data manager in a u-health environment according to one embodiment of the present invention; and

FIG. 6 is a flowchart illustrating the flowchart of FIG. 5 in detail.

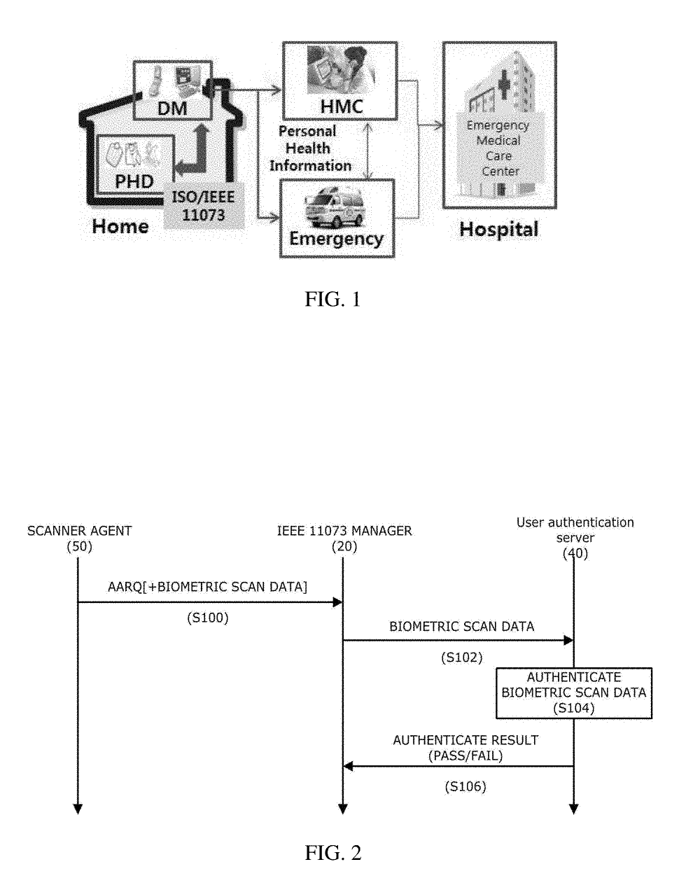

### DETAILED DESCRIPTION OF EXEMPLARY EMBODIMENTS

Processes for mutual authentication between an agent and a data manager in a u-health environment according to one embodiment of the present invention will be described below in detail with reference to the accompanying drawings.

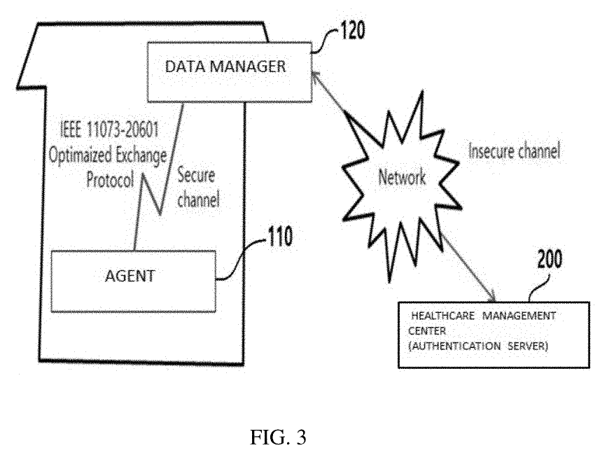

FIG. 3 is a diagram illustrating a schematic system configuration of a u-health environment for implementing the present invention, wherein the system includes an agent 110 for measuring biometric information of a subject in a home u-health environment, a data manager 120 for collecting the biometric information from the agent 110, and a healthcare management center (HMC) (an authentication server) 200 which receives the biometric information of the subject collected through the data manager 120 and stores and manages the biometric information.

In this case, the agent 110 and the data manager 120 transmit the biometric information through a communication protocol of the IEEE 11073-20601 standard through a secure wireless channel.

In addition, the agent 110 is capable of symmetric-key encryption, such as advanced encryption standard (AES), which is an international symmetric-key encryption standard, and the like, the agent 110 and the data manager 120 are capable of encryption/decryption through the symmetric-key encryption, and the data manager 120 and the agent 110 are configured to generate random numbers.

The HMC (the authentication server) 200 serves as an authentication server for mutual authentication between the agent 110 and the data manager 120, and IDs (System IDs) for agents of individual users are registered in a database of the authentication server 200 in advance.

The authentication server 200 may be configured in the HMC 200 which collects and manages biometric information of a subject, the data manager 120 in a home where the subject lives serves as the authentication server, or a separate built-in or external authentication server 200 may be configured in the home where the subject lives.

As described above, the present invention assumes that the HMC is the authentication server 200 and relates to a mutual authentication protocol of the agent 110 and the data manager 120, that is, an authentication scheme between third parties.

That is, generally, in the case of the ISO/IEEE 11073 protocol, which is a mutual data exchange scheme between an agent and a data manager, a message to be exchanged is formed in six formats (which are referred to as application protocol data units (APDU), specifically, AARQ_apdu, AARE_apdu, RLRQ_apdu, RLRE_apdu, ABRE_apdu, and PRST_apdu) as defined in the IEEE 11073-20601 standard.

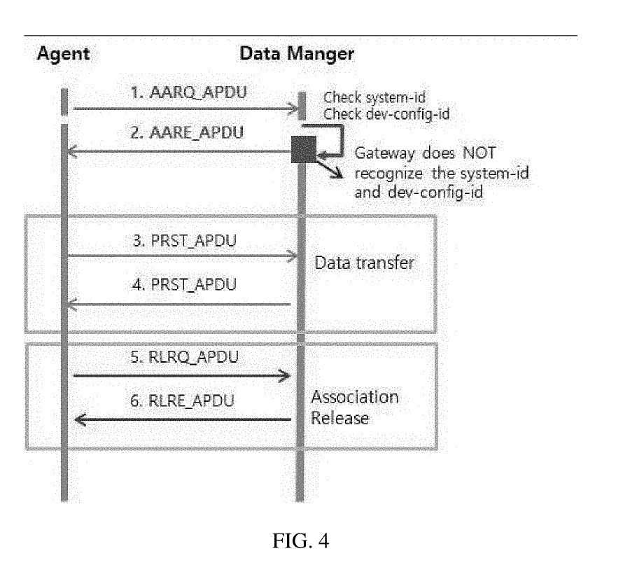

FIG. 4 is a flowchart illustrating ISO/IEEE 11073-20601 communication procedures for implementing the present invention, and the procedures include six steps, and the first two steps (1. AARQ_APDU and 2. AARE_APDU) are for recognizing mutual devices, the next two steps (3. PRST_APDU and 4. PRST_APDU) are for mutual data transfer, and the last two steps (5. RLRQ_APDU and 6. RLRE_APDU) are for association release.

Herein, the present invention relates to the steps prior to an actual data transfer process, i.e., the first two steps (1. AARQ_APDU and 2. AARE_APDU) among the six steps.

Thus, since the present invention allows mutual authentication between the agent 110 and the data manager 120 to be concurrently completed in a process of mutual device recognition between the agent 110 and the data manager 120, an additional overhead due to separate authentication can be somewhat reduced.

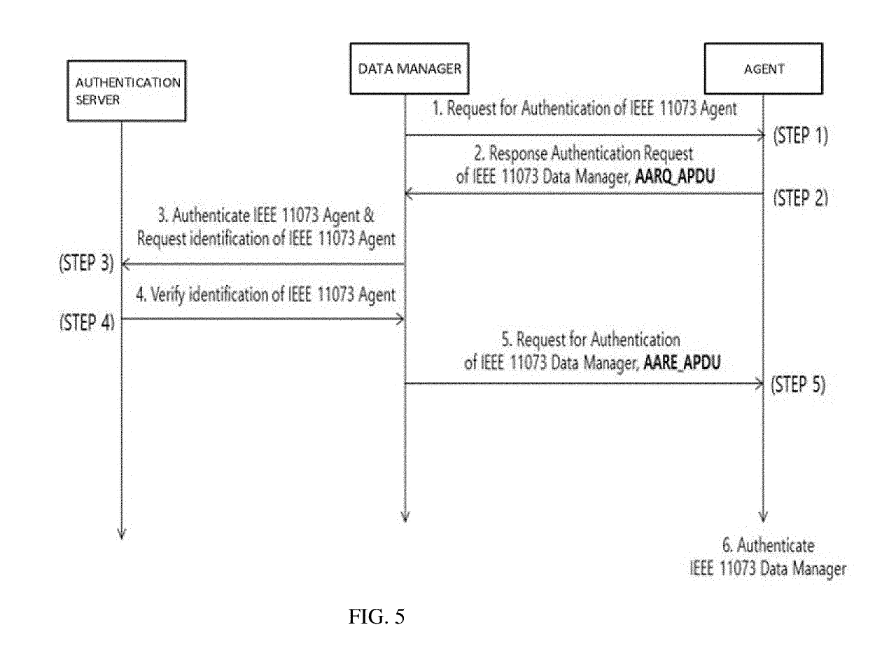

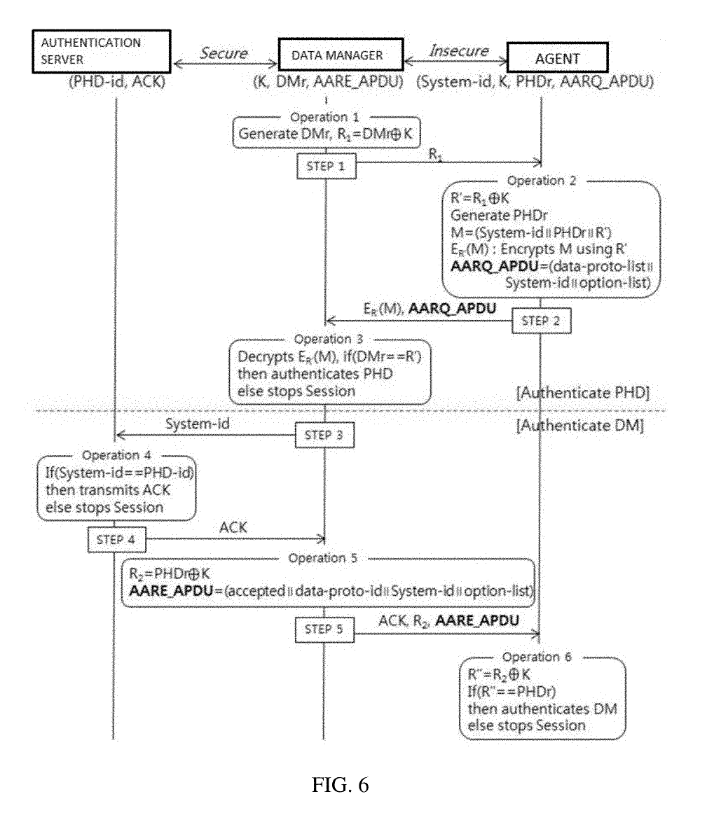

Hereinafter, specific effects and processes according to one embodiment of the present invention will be described with reference to FIGS. 5 and 6.

FIG. 5 is a flowchart illustrating an overall process of mutual authentication between an agent and a data manager in a u-health environment according to one embodiment of the present invention, and FIG. 6 is a flowchart illustrating the flowchart of FIG. 5 in detail.

The present invention employs the following assumptions: first, an identical symmetric key (SK) is initialized and stored in each of the agent 110 and the data manager 120.

Second, an HMC which acts as a kind of the authentication server 200 for mutual authentication between two entities, which are the agent and the data manager, is stored safely, and IDs for agents of individual users (which are known as System ids in an international standard) are registered in a database of the authentication server 200 in advance.

Third, a communication channel that is safe from an attacker's attack is established between the HMC and the data manager, and when the HMC is not configured according to an application environment, the data manager 120 in a home performs such a safe communication channel or a separate built-in or external authentication server is provided in the home.

A section between the data manager 120 and the agent 110 is a radio channel that is vulnerable to the attacker's attack.

Fourth, the agent 110 is capable of symmetric-key encryption, such as “AES” which is an international symmetric-key encryption standard, and the agent 110 and the data manager 120 are capable of encryption/decryption through the symmetric-key encryption.

Last, the data manager 120 and the agent 110 are configured to generate random numbers.

Table 1 below defines terms for describing each process of the present invention.

TABLE 1

| Notation | Description |
|---|---|
| DMᵣ | Random number generated by IEEE 11073 data manager |
| Aᵣ | Random number generated by IEEE 11073 agent |
| System-id | ID of IEEE 11073 agent |
| Agent-id | ID of each IEEE 11073 agent stored in authentication server |
| | of personal HMC |
| K | Secret key calculated in advance and shared between IEEE |
| | 11073 data manager and IEEE 11073 agent |
| ⊕ | Exclusive OR operation |
| ∥ | Concatenation operation |
| E_{K}(M) | Encryption through symmetric-key encryption algorithm |
| | using shared secret key K |
| ACK | Acknowledgement character |

Referring to FIGS. 5 and 6, in a first process (STEP 1), the data manager 120 requests authentication from the agent 110, and more specifically, referring to FIG. 6, the data manager 120 generates a random constant DMr using a one-time use random number generator, performs an exclusive OR (XOR) operation ⊕ on the random constant DMr and the secret key K shared between the data manager 120 and the agent 110 to generate a random number R₁, and transmits the random number R₁ to the agent 110.

A second process (STEP 2) is a process in which the agent 110 responds to the request for authentication received from the data manager 120 (AARQ_APDU), which is described below in detail with reference to FIG. 6.

That is, the second process is a process in which the data manager 120 may verify the agent 110, and the agent 110 performs the XOR operation ⊕ on the random number R₁ received through the first process (STEP 1) and the secret key K shared in advance with the data manager 120 to generate a random number R′.

In addition, the agent 110 generates a random number Ar using a one-time use random number generator (not shown) and calculates a value E_{R′}(M) by encrypting a value M (here, the value M is obtained by concatenating an ID of the agent, which refers to a System-id in IEEE 11073, the random number Ar, and the value R′) through a symmetric-key encryption algorithm using the random number R′ as a secret key.

The agent 110 transmits the encryption calculation value E_{R′}(M) to the data manager 120 together with an AARQ_APDU connection request message specified by the IEEE 11073 standard.

In a third process (STEP 3), the data manager 120 authenticates the identification of the agent 110 and requests that the authentication server 200 verify the identification of the agent 110, which will be described below in detail with reference to FIG. 6.

The data manager 120 decrypts the encryption value E_{R′}(M) received from the agent 110 in the second process (STEP 2) using the symmetric-key encryption algorithm and compares the random constant DMr generated in the first process (STEP 1) with a value R contained in the value M received in the second process (STEP 2) to check whether they are identical with each other.

When the comparison result shows that the values are the same, the identification of the agent 110 is authenticated by the data manager 120, and hence the data manager 120 transmits the System-id, which is the ID of the agent 110, to the authentication server 200 using a secure communication channel so that the agent 110 may authenticate the identification of the data manager 120, and then the process proceeds to a fourth process (STEP 4). When the comparison result shows that the values are not the same, the identification authentication fails, and hence the flow does not proceed to the fourth process (STEP 4) and the session is stopped at the current step (STEP 3).

In the fourth process (STEP 4), the authentication server 200 verifies the identification of the agent 110, which will be described below in detail with reference to FIG. 6.

The authentication server 200 checks whether there is an agent-id that matches a value of the System-id transmitted from the data manager 120 in an ID list of the agents stored in the database of the authentication server 200.

When there is an agent-id that matches the System-id, the authentication server 200 transmits the acknowledgement character ACK to the data manager 120, and the process proceeds to a fifth process (STEP 5). When there is no matching agent-id, the authentication server 200 determines that an error (incorrect or false ID) has occurred, and the session is stopped at the current step (STEP 4).

In the fifth process (STEP 5), the data manager 120 requests the agent 110 for an identification of the data manager 120, which will be described below in detail with reference to FIG. 6.

The data manager 120 calculates a random number R₂ by performing the XOR operation ⊕ on the random number Ar generated in the second process (STEP 2) and the secret key K shared between the data manager 120 and the agent 110 so that the agent 110 can authenticate the identification of the data manager 120.

In addition, the data manager 120 transmits the acknowledgement character ACK received from the authentication server 200 in the fourth process (STEP 4), the random number R₂, and an “AARE_APDU” connection response message specified by the IEEE 11073 standard to the agent 110.

A sixth process is a process in which the agent 110 authenticates the identification of the data manager 120, which will be described below in detail with reference to FIG. 6.

The agent 110 calculates a random number R″ by performing the XOR operation ⊕ on the random number R₂ received from the data manager 120 in the fifth process (STEP 5) and the secret key K shared in advance with the data manager 120. This process is performed so that the agent 110 verifies the data manager 120.

In the sixth process, the agent 110 compares the random number R″ with the random number Ar generated by the agent 110 in the second process (STEP 2) and checks whether they are the same values. When the random numbers R″ and Ar are the same values, it is determined that the agent 110 authenticates the identification of the data manager 120, and hence the session is stopped. In addition, PRST_APDU, which is the third step in FIG. 4, is transmitted so that the process proceeds to a process of transmitting measured personal biometric information data from the agent 110 to the data manager 120.

Subsequent processes are performed in accordance with the communication procedures specified by the IEEE 11073-20601. However, when the random numbers R″ and Ar are different from each other, the identification authentication has failed, and the session is stopped at the current step (STEP 6) without transmitting the PRST_APDU, which is the third step of FIG. 4.

A seventh process proceeds in the same manner as the PSRT_APDU step which is the third step of the IEEE 11073-20601 communication procedures. The processes from the first process (STEP1) to the sixth process (STEP6) correspond to the AARQ_APDU connection request, which is the first step of the IEEE 11073-20601 communication procedures shown in FIG. 4, and an AARE_ADPU connection response, which is the second step of the communication procedures, and thus the seventh process is performed from PRST_APDU, which is the third step in which measured biometric data is transmitted, and the subsequent processes conform to an existing protocol proposed by the IEEE 11073-20601.

As described above, a method of mutual authentication between an agent and a data manager in a u-health environment according to the present invention is a new method of mutual identification authentication between an agent, which is a user in the conventional IEEE 11073 standard, and a data manager using a HMC as an authentication server, and mutual identification authentication between the agent, which is the user, and the data manager is performed using encryption and a one-time use random number generator. In addition, since identification recognition is carried out using an ID of the agent (a System-id), a secret key, encryption, and the one-time use random number generator, it is possible to perform encryption without using biometric scan data, and bidirectional authentication, rather than unidirectional authentication, is possible using the one-time use random number generator.

In addition, since mutual authentication is concurrently performed before mutual data transmission between the agent and the data manager in the process of recognizing each device, an additional overhead due to separate authentication can be somewhat reduced.

Moreover, given a low power characteristic of the agent device, the present invention is very efficient in terms of an amount of computation as each of the agent and the data manager generates a random number once and performs an XOR operation twice and an encryption/decryption operation once. Also, a random number is used in an encryption/decryption process so a value to be transmitted is not only variable but is also safe from attacks by unauthorized third parties, such as eavesdropping, location tracking, spoofing, retransmission, and the like.

In particular, the present invention can be applied directly to the ISO/IEEE 11073-20601 standard, and hence a mutual authentication function is added to the agent and the data manager, thereby implementing a safer and more efficient remote medical environment.

It should be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

### REFERENCE NUMERALS

110: Agent

200: Authentication Server

120: Data Manager

What is claimed is:

1. A method of mutual authentication between an agent and a data manager in a u-health environment in which the data manager collects biometric information of a subject obtained from a plurality of agents and transmits the biometric information to an authentication server, the method comprising:
mutually recognizing devices of the data manager and each of the agents and performing mutual authentication using a random number generated by a random number generator;
transmitting the collected biometric information between each of the agents and the data manager after the recognition of the devices and the mutual authentication; and
terminating a connection between each of the agents and the data manager when the transmission of the biometric data is finished.

2. The method of claim 1, wherein identical symmetric keys to be encrypted and decrypted through symmetric-key encryption are safely initialized and stored in each of the agents and the data manager.

3. The method of claim 1, wherein the data manager and each of the agents generate the random number using the random number generator.

4. The method of claim 1, wherein the authentication server registers and manages an identification number (ID) for an agent of each subject for the mutual authentication between each of the agents and the data manager.

5. The method of claim 4, wherein the authentication server is included in a healthcare management center which collects and manages the biometric information of the subject, the data manager in a home where the subject lives serves as the authentication server, or a separate built-in or external authentication server is provided in the home in which the subject lives.

6. The method of claim 1, wherein the agent, the data manager, and the authentication server in a u-health environment specified by international standard IEEE 11073 are configured to measure and collect personal biometric information at a home and transmit the personal biometric information to a healthcare management center.

7. The method of claim 1, wherein the mutually recognizing of the devices and the performing of the mutual authentication includes mutually performing identification authentication between the agent and the data manager using encryption and a one-time use random number generator through the authentication server.

8. The method of claim 1, wherein the performing of the mutual authentication includes:
a first process in which the data manager requests personal authentication of the subject from the agent;
a second process in which the agent responds to the request for authentication from the data manager;
a third process in which the data manager authenticates an identification of the agent and requests that the authentication server verifies the identification of the agent;
a fourth process in which the authentication server verifies the identification of the agent and transmits the verification result to the data manager;
a fifth process in which the data manager requests that the agent authenticates an identification of the data manager; and
a sixth process in which the agent authenticates the identification of the data manager.

9. The method of claim 8, wherein the performing of the mutual authentication includes performing identification recognition using a System-id, which is an ID of the agent, a secret key, encryption, and a one-time use random number generator.

10. The method of claim 8, wherein the first process includes:
step 11 in which the data manager generates a random constant (DMr) using a one-time use random number generator; and
step 12 in which a random number (R₁) is generated by performing an exclusive OR (XOR) operation on the random constant (DMr) and a secret key (K) shared between the data manager and the agent and then the random number (R₁) is transmitted to the agent.

11. The method of claim 8, wherein the second process includes:
step 21 in which a random number (R′) is generated by performing an XOR operation on a random number (R₁) transmitted through the agent and a secret key (K) shared in advance with the data manager;
step 22 in which a random number (Ar) is generated using a one-time use random number generator and an encryption value (E_{R′}(M)) is calculated through a symmetric-key encryption algorithm using a value M (obtained by concatenating a System-id and the random numbers (Ar and R′)) as a secret key; and
step 23 in which the encryption value (E_{R′}(M)) and a connection request message (AARQ_APDU) are transmitted to the data manager.

12. The method of claim 8, wherein the third process includes:
step 31 in which a random constant (DMr) generated in the first process is compared with a random number (R′) transmitted in the second process and checks whether the random constant (DMr) and the random number (R′) are the same values; and
step 32 in which when the comparison result of step 31 shows that the random constant (DMr) and the random number (R′) are the same values, the identification of the data manager is authenticated.

13. The method of claim 12, wherein the random constant (DMr) is generated in the first process by decrypting an encryption value (E_{R′}(M)) transmitted from the agent in the second process using a symmetric-key algorithm.

14. The method of claim 12, wherein in step 32, the data manager transmits a System-id of the agent to the authentication server using a communication channel.

15. The method of claim 12, wherein in step 31, when the comparison result of step 31 shows that the random constant (DMr) and the random number (R′) are different from each other, it is determined that the identification authentication is failed and a session is stopped in a current state.

16. The method of claim 8, wherein the fourth process includes:
step 41 in which the authentication server checks whether an ID (a System-id) of the agent transmitted from the data manger matches a previously stored agent id; and
a step in which a response acknowledgement message ACK is transmitted to the data manager when the transmitted ID (the System-id) matches the previously stored agent id in step 41.

17. The method of claim 16, wherein in step 41, it is determined that the transmitted ID (System-id) of the agent does not match the previously stored agent-id, it is determined that an error has occurred and a current session is stopped.

18. The method of claim 8, wherein the fifth process includes:
step 51 in which the data manager calculates a random number (R₂) by performing an XOR operation on a random number (Ar) generated in the second process and a secret key (K) shared between the data manager and the agent so that the agent authenticates the identification of the data manager; and
step 52 in which a response acknowledgement message (ACK) transferred from the authentication server in the fourth process is transmitted to the data manager together with a connection response message (AARE_APDU).

19. The method of claim 8, wherein the sixth process includes:
step 61 in which the agent generates a random number (R″) by performing an XOR operation on a random number (R₂) received from the data manager in the fifth process and a secret key (K) shared in advance with the data manager;
step 62 in which the agent compares the calculated random number (R″) with a random number (Ar) generated by the agent in the second process and checks whether the random number (R″) and the random number (Ar) are the same values; and
step 63 in which when the same values are determined in step 62, it is determined that the agent authenticates the identification of the data manager.

20. The method of claim 19, wherein the transmitting of the collected biometric information is performed after the agent authenticates the data manager in step 63.
